(19) United States
(12) Patent Application Publication
(10) Pub. No.: US 2009/0088245 A1
(43) Pub. Date: Apr. 2, 2009

(54) Marketing System and Method for Customer Specific Promotions

(76) Inventors: Keith A. Klinkhammer, Newport, OR (US); Craig Casey, Lansdowne, PA (US)

Correspondence Address: HOWARD & HOWARD ATTORNEYS PLLC, 450 West Fourth Street, Royal Oak, MI, 48067, US

(21) Appl. No.: 12/330,897

(22) Filed: Dec. 9, 2008

Related U.S. Application Data
(63) Continuation of application No. 11/401,092, filed on Apr. 10, 2006, now abandoned.
(60) Provisional application No. 60/670,069, filed on Apr. 11, 2005.

(51) Int. Cl. A63F 9/24; A63F 13/00

(52) U.S. Cl. 463/29

(57) ABSTRACT

A marketing system and method for customer specific promotions providing a yield management tool for casino resort properties to more effectively manage entertainment related assets and inventories to build new and existing customer business. The system provides a convenient method for consumers to realize promotional incentives proportional to their player wagering status at a broader level within the casino resort industry while simultaneously delivering casino resort operators a cost effective tool to maximize the value of their assets. The system utilizes register user supplied player wagering and comp data, and historical waging data on said registered users collected by the system from participating casino resort properties to build a broad-based casino customer database defining the waging profiles of individual gaming customers. Built on the foundation of this industry-wide database resource, the system's electronic transaction platform construction provides casino resort properties a facility to interact directly with gaming oriented customers to present compelling, customer specific promotional offers at the point of purchase where said customers make casino resort air/room travel plans and review purchase decision options.

### RELATED APPLICATIONS

This application claims the benefit and priority of U.S. Provisional Application for Patent Ser. No. 60/670,069 filed on Apr. 11, 2005.

### BACKGROUND OF THE INVENTION

Over the past thirty years America has evolved from a place where gambling was a relatively rare activity with casinos operating only in the Nevada, and a few states operating lotteries, and pari-mutuel gambling on a smallish scale, into a nation where legalized gambling, in one form or another, is one of the more popular leisure activities. The amount spent on gambling compared to all other leisure activities is particularly noteworthy. In 2004, more than ten percent of the over $650 billion Americans paid for leisure goods, services and activities was spent on gambling, not including monies spent by gamblers on hotels, food, transportation and other related expenses. In terms of “destination leisure” (e.g., spectator sports, cruise ships, theme parks, concerts, etc.), “destination” gambling accounts for more than one-third of total market revenues. And of all gambling categories, casino gambling is the most popular, generating over 50% of the total commercial gambling revenues for all categories.

As the casino resort and gaming industry has grown and matured, the use of entertainment to drive gaming revenue has continued to be the market's principal proven formula for success. In Las Vegas, entertainment (non-gaming) related revenue now accounts for over 40% of total casino gross revenues. Las Vegas' successful entertainment driven formula is the model for other major casino resort destination markets striving to increase their potential.

Two factors influencing casinos decisions related to management of their entertainment assets and investments are the (i) fixed cost, and (ii) perishable nature of related inventory. Entertainment products are generally characterized by fixed versus variable cost based investments (i.e., facilities, maintenance, entertainer fees, etc.) and corresponding inventory is predominantly “perishable”. Therefore, many important expense levels cannot be readily adjusted downward if necessary to meet lower than average or projected sales levels, and if an inventory allotment for any given day is not sold (e.g., hotels room, seat at a boxing match, etc.) related revenue potential is lost and can not be recovered.

As a result of the popularity of casino gaming, the number and size of casino resorts has seen rapid and continued growth. Similarly competition between casino resorts to attract and retain gaming customers has intensified. Casino sponsored entertainment such as shows, events, and night clubs, is the most popular method used by casinos to attract gaming customers, and “comps” are one of the most widely recognized promotional tools to use entertainment assets to successfully build and retain valued gaming business.

“Comp” is the casino industry term for special promotions, e.g., free rooms or upgrades, tickets to events, complimentary food and beverages, provided to customers to foster goodwill and build customer loyalty. The level of comps a casino may provide to a customer is generally based on an individual players rating or value to a casino, as typically determined from the customer's historical level of play or wagering.

Casino rating systems utilize various methods to track players wagering history. Related historical data is utilized to determine such information as a player's average wager, amounts wagered during an average gaming session, type of games preferred, frequency of visits per year, etc. This data provides casinos with the ability to reward individual customers with comps that are proportional to each customer's unique wagering status. With accurate historical waging data, casinos can make promotional comp commitments more quickly to their customers to attract or retain their business and prevent the danger of (i) over spending based on the customer's actual value to the casino, or (ii) failing to provide treatment and accommodations for valuable customers at levels to which the customers are accustomed or entitled.

Casinos issue “player cards” to track the wagering activity of their customers during their casino stay or visit. Player cards are common enough to be considered a standard, industry-wide feature. Customer data that individual casino properties acquire from player cards is proprietary to the casino property collecting the customer data or to the casino owners. Therefore, such data is typically not shared between or among competing casino operations.

The absence of an industry wide, shared historical wagering data platform creates a “disconnect” when players with established waging histories at one casino seek to patronize a second casino where they have no wagering history. In these instances, the second casino is ill prepared to quickly or conveniently provide such customers with comps at levels they may be accustomed to. This “walled garden” data structure that limits customer's freedom of choice by curtailing efficient, automated transfer of wagering profile related casino privileges or entitlements.

Numerous business models have proven that consumers tend to retaliate when their access or freedom is arbitrarily limited. As a result, the use of containment tactics in businesses can have the affect of lowering overall customer satisfaction levels and potentially limiting a markets true potential.

One prior arrangement provides a multi-player tracking system that tracks a player's wagering levels at any one of a several gaming venues. This system, however, requires a “new” management information system be installed over the top of the current information system at each casino property. It is commonly known that whenever a new system installation requires an existing business system to be changed or replaced, particularly where large established companies are concerned, a significant amount of time and expense is generally required to affect such change. Furthermore, such requirements can also prohibit adoption altogether.

Promotional activities such as providing “comps” motivate and stimulate consumer purchases. People are attracted by the opportunity to win or receive things perceived as being free. In fact, use of the “free” is so effective in motivating consumer purchase decisions that use of the word is regulated in certain industries to prevent abuse.

### SUMMARY OF THE INVENTION

In accordance with the principles of the invention “comps,” generally perceived by customers as free bonuses or rewards, are more effectively utilized as an important and compelling promotional tool for casinos. Accordingly, access to a universally accessible player wagering profile database would open up the market for casinos to use comps to more readily promote growth and profitability using a more efficient, automated system.

We have determined that what would greatly benefit the casino industry and casino consumers to provide an arrangement that (i) collects consumer related wagering profile data and stores it to a non casino specific wagering database, (ii) aggregates such data, in a cumulative manner, into a database that can is accessible by participating casino members, and (iii) provides a casino travel related website where casinos, having electronic access to said player wagering data, can offer individually tailored, incentive comp packages to attract new customer business and motivate existing customers to increase their frequency of visits.

A method in accordance with the invention includes: providing a database of customer wagering profiles; receiving a request from a potential customer for a destination casino hotel reservation; obtaining wagering profile data for the potential customer from the database; providing a modified or enhanced request by attaching the wagering profile data for the potential customer to the enhanced request; utilizing the enhanced request to generate one or more promotional incentive offers; and responding to the request with at least one reservation option including said one or more promotional incentive offers.

A marketing method for customer specific promotions in accordance with the invention includes: receiving from a requesting customer an electronic request for promotional offers via a website connected to a global computer network or via a device located in a casino and coupled to a communications network; attaching wagering profile data from the requesting customer to the electronic request to provide an enhanced request; sending the enhanced request to one or more casino properties to produce promotional incentive offers corresponding with the request, the incentive offers being proportional to the requesting customer's wagering profile; and responding to the request with one or more promotional offers.

### BRIEF DESCRIPTION OF THE DRAWING

The invention will be better understood from a reading of the following detailed description in conjunction with the drawing figures in which like designators are used to identify like elements, and in which:

FIG. 1 illustrates a system in accordance with the principles of the invention;

FIG. 2 illustrates steps in registering a user of the system and method of the invention;

FIG. 3 illustrates steps in providing incentive offers in accordance with the principles of the invention;

FIG. 4 illustrates principal components of the customer specific marketing system and method including a participating casino property, data interfaces, and customer wagering profile database and casino destination travel website;

FIG. 5 illustrates the participating casino property operations components and wagering data access, transferred and sharing arrangements in a preferred system structure;

FIG. 6 illustrates a method by which consumers enroll as registered users of the system and establish system accounts;

FIG. 7 illustrates the method by which the registered users wagering data is captured from participating casinos and the processing of such data within the systems database operations;

FIG. 8 illustrates how registered users operate the system website and the related system interaction with participating casino properties to develop promotional comp package offers for such registered users; and

FIG. 9 illustrating a sample system generated casino air/room travel package options and the structure and process by which registered users select such travel package options.

### DETAILED DESCRIPTION

When a casino's historical data modeling tools or reservation records, or similar tools or data sources, project or indicate a probability there will be unsold inventory levels, it is highly desirable for casino operators to utilize such potentially unsold inventory as a promotional tool to attract gaming business (since corresponding incremental expense requirements for such promotional use are generally small and if the inventory is not used it is lost anyway).

The present invention provides a highly effective yield management tool for the casino resort industry to optimize the value of entertainment related assets by providing access to an industry-wide wagering profile database and features to use this data to design customer specific comp promotions to attract new customers and increase business from existing customers.

In accordance with the principles of the invention a yield management strategy for casino operators provides (i) access to a potential customer while the potential customer is making casino resort destination travel purchase decisions, (ii) the ability to make and modify promotional comp package incentive offers to a potential customer in real time, and (iii) access to accurate data on each potential customer's historical waging data to tailor promotional offers on a per customer basis.

A casino property participates in and uses a customer specific marketing program in accordance with the invention after entering into an agreement to be a participant. In accordance with the agreement the participating casino provides registered user waging data collected by the casino to a system database. Still further a participating casino agrees to promote enrollment in the system to its patrons.

Any member of the general public may enroll to become a system user on-line via a system supported web site or at terminals or kiosks located in participating casinos. The terminals or kiosks are programmed to read system registered user account cards. Each prospective user of the system participates in a registration process. During the registration process, the prospective user enters appropriate identification information, gaming preferences and wagering profile data. The information entered by the prospective user is checked for integrity and entered into a database along with a user account code or number which is provided back to the user at conclusion of the registration process.

When a registered user utilizing a web site enters casino destination travel plans, the system identifies participating casino properties at geographically relevant locations. By way of example, a registered user may indicate that he or she would like to stay in a casino-resort located on the “strip” in Las Vegas or in Atlantic City or elsewhere. The system will associate the desired travel plans along with the user's waging history profile data from the system database. The system transmits a requestor's identity information, travel request travel dates or visit specifications and wagering profile data to geographically relevant participating casino resorts.

The participating casino resorts utilizing one or more software programs to draw on inventory management data generate promotional offers in response to the potential customer's that are proportional to the user's wagering profile and the currently available inventory to said registered users. The promotional offer or offers are returned to the user who has initiated the request.

By providing wagering profile data and working in cooperation with participating casinos, the system of the present invention offers relevant and valuable promotional incentive packages to its registered user customer base. As the casino industry matures, casinos continue to develop a wider array of premium entertainment services that can be provided as incentives for casino brands to attract and retain customers. Such premium entertainment, however, comes at a significant expense to casino properties and therefore must be carefully managed. As a safeguard, in order to offer such premium entertainment as a comp to secure potential customer business, casino properties need assurance that such promotional investments are proportional with the waging level of recipient customers. With access to the system's database, casinos are provided with efficient, automated access to important customer specific wagering profile data on an industry-wide level so they can focus their decision processes inventory management variables to maximize their yield in real time. And the more history wagering profile data available to a casino the easier it is for such casinos to offer incrementally greater promotional incentives to attract and retain customers. As a result, the system provides a compelling reward based program to motivate players to become registered users and actively participate (with the system) to build the broadest, most comprehensive player wagering history they can.

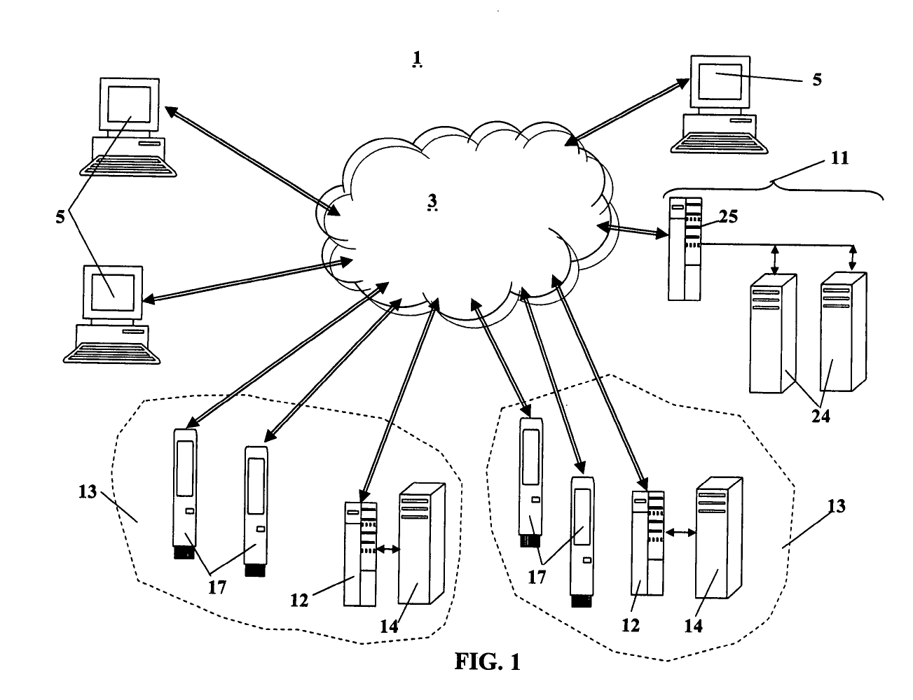

Turning now to FIG. 1, participating resort-casino properties 13 each include a computer system 12 that has access to a database 14. Database 14 includes wagering data for past and current casino players. The records stored in database 14 are associated with players such that wagering data may be selectively retrieved or updated for each player registered in database 14. Casino computer system 12 also has access to promotional comp information for various comps that resort-casino property 13 has determined are available for players. Examples of such comp information is inventory information for entertainment, meals and rooms. The comp information is stored in database 14 also. It should be noted that although one database 14 is shown, in fact, there may me multiple databases that are utilized to store the comp information and player wagering data. In addition, each participating resort-casino property 13 may separately determine the correlation between various wagering determinative factors recorded in database 14 and comps that may be offered to a prospective guest.

System 11 includes a server 25 and its related databases 24. Server 25 responds to reservation requests received from prospective resort-casino property guests that are received via an electronic network 3 which, in the illustrative embodiment of the invention, is the Internet. A prospective guest may utilize an Internet accessing device 5 which may, for example, be a computer terminal, pda, internet accessing cell phone or other such device to access server 25 via Internet 3. Alternatively, the prospective guest may access another web site which in turn is linked to server 25. In any event, a prospective guest is initially asked via terminal 5 whether he or she is a registered user of system 11.

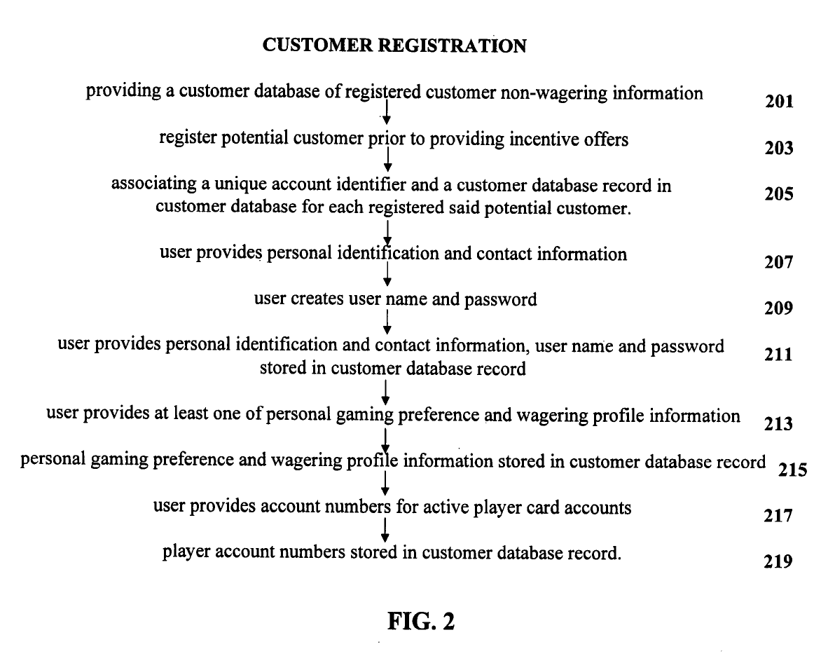

FIG. 2 illustrates the registration process for a new user of system 11. The system of the invention maintains a database of registered customers at step 201. When a system user or prospective guest logs onto system 11, the prospective guest is linked directly or indirectly to server 25. At step 203 it is determined whether or not the prospective guest is already a registered member. If the guest is a registered member, the guest logs in to the system by entering identification information. System 11 verifies the log in of the guest and the guest may then enter travel destination information is asked to provide his/her registration identification if he/she is a registered user.

If prospective guest is not a registered user, the prospective guest is asked to register to use the system at step 203. A unique identifier and As part of the registration process, the prospective user is requested to and must provide identification information, and player club information for all casinos where the prospective user has registered to provide a user profile. System 11 associates a unique account identifier and a customer database record in customer database for each registered potential customer at step 205. The user provides personal identification and contact information at step 207 and the user creates user name and password at step 209. The user provides personal identification and contact information, and selects a user name and password which are stored in customer database record at step 211. The user provides at least one of personal gaming preference and wagering profile information at step 213. System 11 stores personal gaming preference and wagering profile information stored in customer database record at step 215. The user provides account numbers for active player card accounts at step 217 and the player account numbers stored in customer database record at step 219

The user then may log on to use system 11. As with a previously registered user, system 11 verifies the log in. If the log in is not verified, the user is returned to a log in page. If the log is verified server 25 accepts reservation information from the prospective guest.

Server 25 provides prompts to the user for obtaining appropriate reservation information from the user, including geographic destination information and desired dates and other typical reservation information. Once server 25 receives the reservation request information from the user, server 25 obtains wagering data for the guest from database 24 and appends the wagering data to the reservation request.

Server 25 identifies participating casino properties that meet the geographic preference of the user. Server 25 transmits the reservation request and wagering data to the participating casino properties that have been identified.

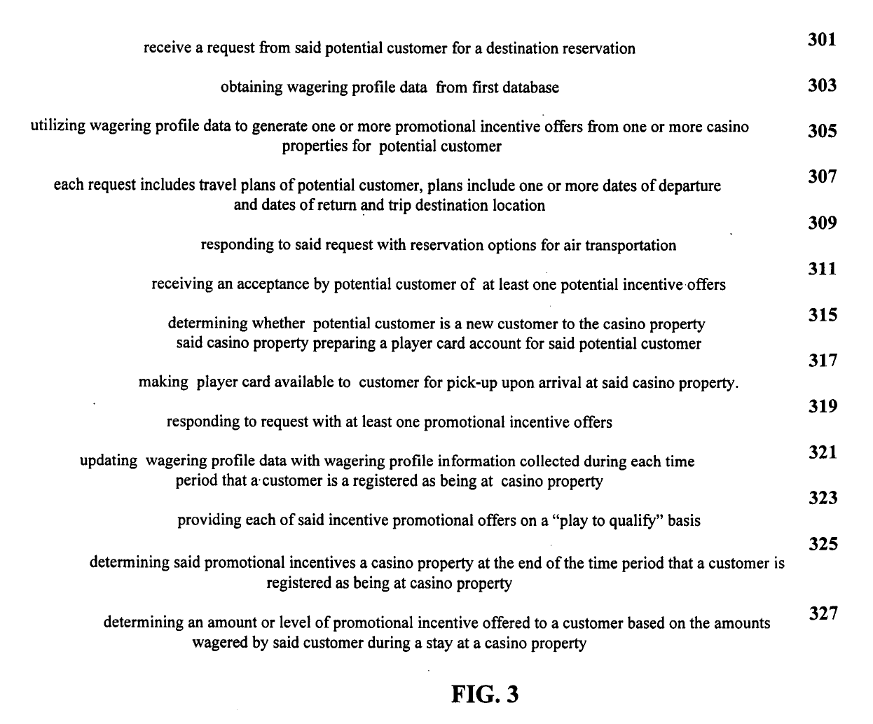

As shown in FIG. 3, System 11 receives a request from said potential customer for a destination reservation at step 301. System 11 obtains wagering profile data from first database at step 303. System 11 utilizes wagering profile data to generate one or more promotional incentive offers from one or more casino properties for potential customer at step 305. System 11 responds to the request with at least one promotional incentive offer. Each request includes travel plans of potential customer, plans include one or more dates of departure and dates of return and trip destination location at step 307. System 11 responds to said request with reservation options for air transportation at step 309. After receiving an acceptance by potential customer of at least one potential incentive offers at step 311, the system provides acceptance to the casino property. During this process system 11 determines whether the potential customer is a new customer to the casino property at step 313. If so, the casino property prepares a player card account for said potential customer at step 315. The casino property makes the player card available to customer for pick-up upon arrival at said casino property at step 317. System 11 updates wagering profile data with wagering profile information collected during each time period that a customer is a registered as being at casino property at step 321. The casino may provide each of said incentive promotional offers on a “play to qualify” basis at step 323. In such case, the casino will determine the promotional incentives at the end of the time period that a customer is registered as being at casino property at step 325. The amount or level of promotional incentive offered to a customer may be based on the amounts wagered by said customer during a stay at a casino property at step 327

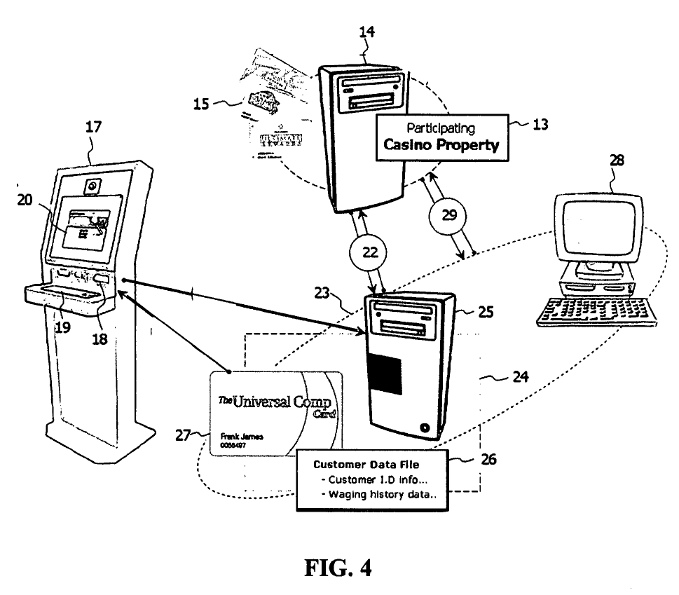

As illustrated in FIG. 4, participating casino properties 13 identified as being within the destination receive the reservation request and the wagering information for the requesting user. The casino computer system 12 accesses its data base at step 303 to identify its available inventory for the prospective guests choice of date. Casino computer system 12 may also access its players club database if the prospective user is a member of its players club.

Casino computer system 12 utilizing the reservation request information, the wagering data appended to the reservation request and its inventory, to generates one or more promotional incentives to induce the prospective guest to utilize its facilities. The promotional incentive is appended to a response to the prospective guest that is returned to server 25.

Server 25 assembles responses from all participating casinos that respond to the reservation request and makes the responses available to the prospective user for access via the Internet.

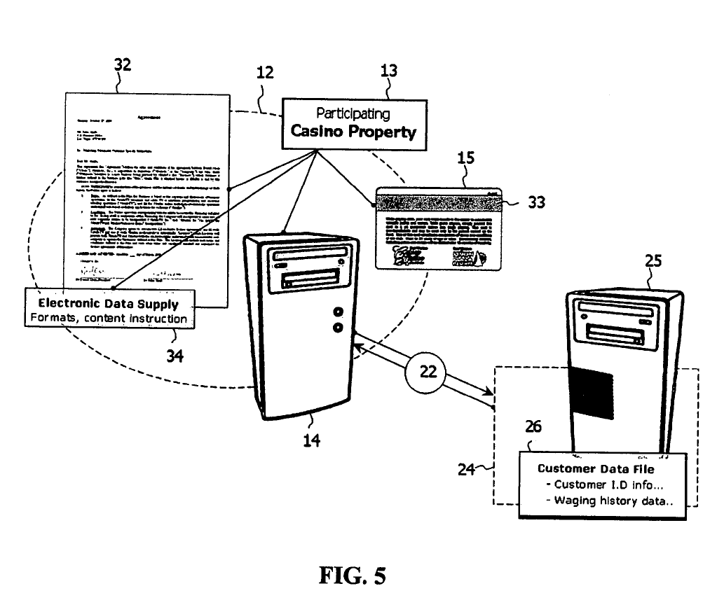

Turning now to FIG. 5a resort-casino property 13 is shown schematically. It will be appreciated that although only one resort-casino property is shown in FIG. 5, the principles of the invention are applicable to a group of related resort-casino properties or groups of related casino properties or a group of unrelated casino properties. Casino-resort property 13 includes a computer system 12 that either includes or has access to a database 14. Casino-resort property 13 includes a players club and issues players club cards 15.

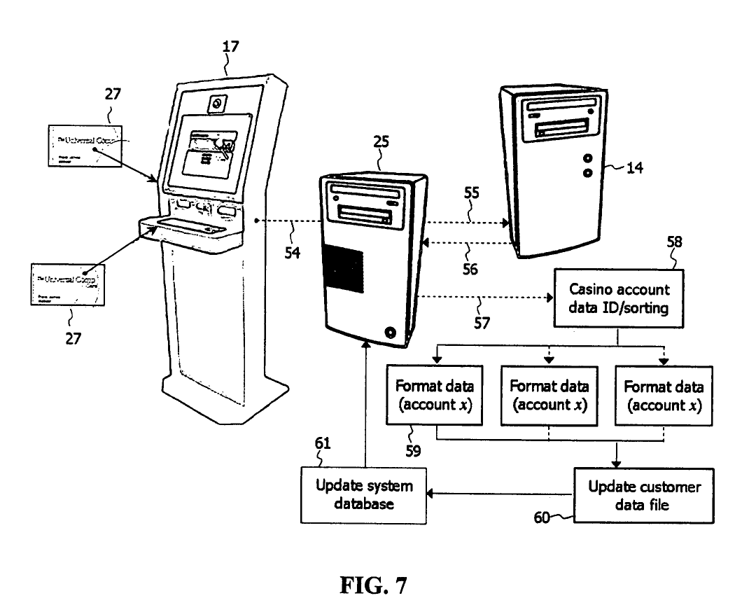

One or more kiosks 17, shown in greater detail in FIG. 7 are co-located at resort-casino 13. Each kiosk 17 includes a card reader 18 for reading of system cards 27, a keypad input device 19 and a graphical display 20. Kiosks 17 are shown illustratively. The particular appearance and structure of each kiosk forms no part of the present invention. It is intended that the use of the term “kiosk” herein is intended to include any substantially freestanding input/output terminal that would be placed in a public area for use by the general public.

As illustrated in FIG. 5 a casino property operation becomes a participating casino property 13, by entering into an agreement 32 agreeing to provide server 25 access to casino database 14 for providing wagering data collected from registered users during the period such users are actively involved in gaming at the participating casino property 13. Upon executing the agreement 32 participating casino properties 13 provide appropriate data formatting information and necessary code/content instruction 34 from the participating casino property management information system administrator. A participating casino property 13 shares wagering history data that guests registered with system 11 generate while playing at the participating casino property 13 and transfers such data from casino database 14 to system 11.

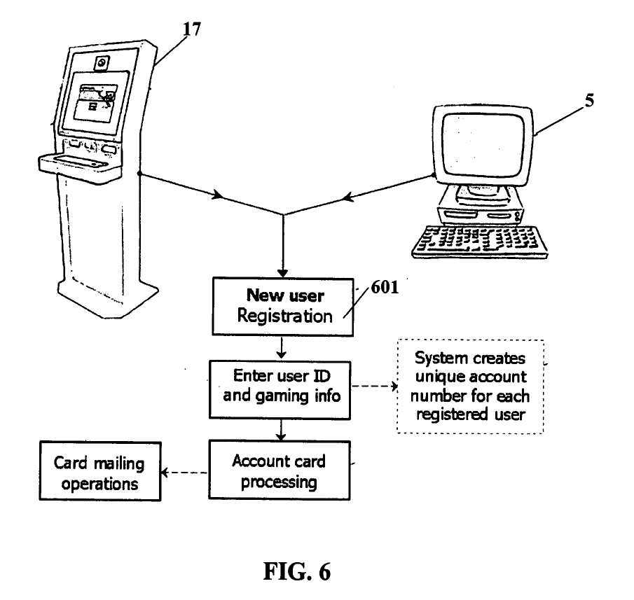

FIG. 6, illustrates two ways a customer may enroll as a registered users of system 11. A customer can enrollment to become registered users at either a kiosk 17 or via the Internet utilizing an internet accessing device 5. The customer receives appropriate instructions to register via a registration screen at step 601. At the new user registration screen, consumers input user identification and contact information (i.e., mailing address, phone numbers, etc.) and information related to gaming preferences and wagering related profile data 43. The new user is prompted to enter account username and password information. Thereafter the system 11 creates a unique account number 44 for the new registered user to manage and maintain a corresponding registered user customer data file 26 within the system 11 database 24. System 11 transfers the corresponding registered user customer data file 26 to an account card processing center 45 to process a registered user system account card 27.

Subsequent to completing registration, a registered user is provided a system account card 27. System account card 27 includes memory, which in the illustrative embodiment is a readable/writeable magnetic data strip thereon compatible with kiosk 17. The magnetic strip allows the registered user to view account profile data 26 or have the account data 26 on the system account card 27 updated at a system kiosk 17.

A registered user can access system 11 to make casino destination air/room travel plans. When a registered users checks in at a casino-hotel, the hotel check in and check out times serve as automatic start time and stop time indicators eliminating the need to use the user card 27 at a system kiosk 17 to mark data collection start and stop times.

Turning back to FIG. 4, a registered user inserts an account card 27 into kiosk 17 reader 18 at the beginning of a participating casino gaming session. The registered user also inserts an account card 27 into a reader 18 at the conclusion of a session 16 to indicate to the system 21 the period of time the registered user was actively engaged in gaming activity at the participating casino property 13. Upon collecting the start and stop time information 21, the system 11 sends an electronic request 22 to casino database 14 for wagering data for the registered user for the corresponding gaming period. System 11 converts the captured and transferred wagering data into an appropriate database format for storage in the system database 24. Every system registered user has a customer data file 26 which stores registered users customer identification information and compiled and aggregated wagering history data from system 11.

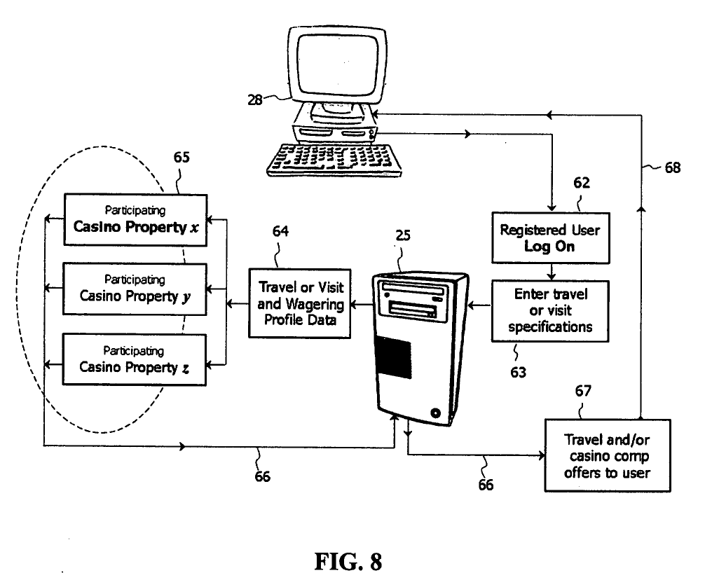

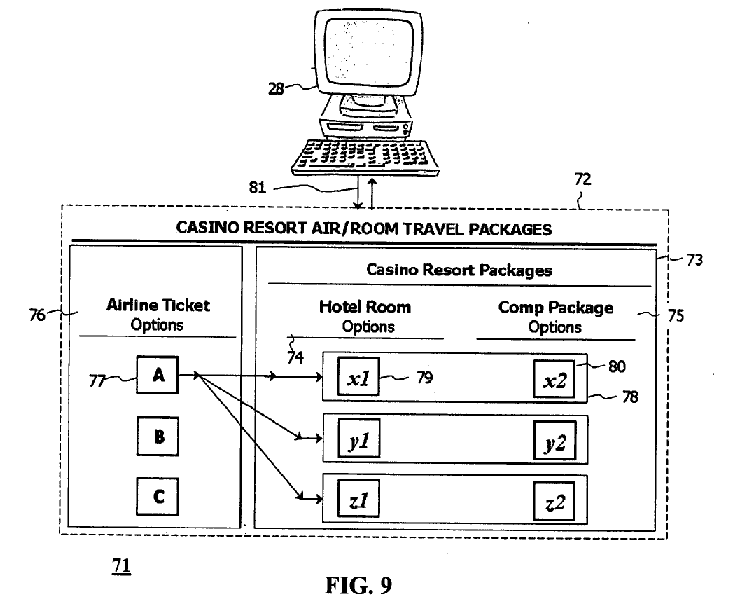

As shown in FIGS. 8 and 9, the system's marketing operation platform 23 includes a website 28 where registered users can book casino destination air/room reservations and/or request and receive casino comp offers corresponding with their walk in casino visit plans.

In accordance with the principles of the invention a terminal or kiosk 17 located within participating casino properties 13 is used to register a start 52 and stop 53 time relative to a registered users gaming activity at a participating casino during a corresponding gaming. At the onset of a gaming session a registered user swipes their system card 27 in the system kiosk 17 reader 18 and keys in the appropriate instruction at the keypad 19 to log the start time of the registered users gaming session 52. At the conclusion of the a gaming session the registered user swipes their system card 27 in the system kiosk 17 reader 18 and keys in the appropriate instruction at the keypad 19 to log the stop time of the registered users gaming session 53.

After a registered user logs their gaming session ending time, an electronic data file defining account number for the registered user, the wagering session time and corresponding participating casino that was wagered at is sent to the system database operations server 25. A copy of this data along with a request for the corresponding wagering profile data for the gaming session period is sent 55 from the system database server 25 to the casino database 14. Upon receipt of the electronic request 55 from the system 11 the casino database 14 transmits 56 back to the system server 25 with the corresponding registered users wagering data for the gaming session period. Upon receipt of request wagering profile data 56 the system server 25 sends the casino 13 data to the next sequential data processing operations 57. The systems casino account identification and sorting operations 58 analyze the historical wagering data files 22 to determine the originating registered casino account for the participating casino 13. Once the originating registered casino account is determined, the corresponding casino property 13 electronic data format 34 information is retrieved and wagering data 22 is converted to the system's 11 format 59. Thereafter, the system 11 updates the corresponding registered user's data file 26 with the historical wagering data 60 and then updates the central system database operations 61.

As shown in FIGS. 8 and 9 registered users may request casino destination travel airline ticket and hotel reservation pricing 61 and receive as part of the request 61, promotional comp incentives offers 68 at the system 28 website.

When a registered system user enters the system 11 website 28 to search for casino destination travel and entertainment package options, they log on as a registered user 62 and enter their desired travel specification (date and city of departure, return date, number of passengers, etc.) 63. Via the system 11 server 25 the system database operations 24 then combines the registered users travel specifications 63 with the registered users customer data file 26 wagering history data and electronically transmits this customer and travel plan information to participating casino properties 13, 65 at relevant locations (in geographical proximity to destination of registered users travel plan specifications 63). With the registered user/system 11 supplied travel specifications 63 and corresponding registered user wagering history data 26 the participating casino resorts 13 utilize their own internal, inventory/yield management software programs to prepare promotional offers tailored to the travel specifications 63 and customized for the registered users wagering history data 26 and transmit 66 to the system 11 server 25 and database operations 24. The promotional offers 67 are then sent 68 to the website 28 for the registered user to review.

As shown in FIG. 9 a system 71 that defines the format of system responses to requests 61 for casino air/room travel package pricing and options. Casino resort air/room travel packages 72 delivered by the system 11 include a casino resort package 73, made up of a hotel room options 74 and comp package options 75, and airline ticket options 76. Airline ticket options 76 are made up of a multiple of individual airline ticket options 77 from one or more carriers. Similarly, casino resort package options are made up of a multiple of individual hotel room choices 79 from various casino properties 13 and multiple of individual comp package options 80. Any airline ticket option 77 can be freely interchanged with any hotel room/comp package set 78. Hotel room 79 and comp package components 80, however, of a casino resort package option 78 can not be removed from their package and interchanged with other casino resort 74 hotel room 79 or comp package 80 components.

At the conclusion of registered user's gaming sessions or trips to participating casinos, electronic requests for corresponding wagering data is sent to the casino. Upon collection, the wagering data is added to the users' customer data file in the system database. Related wagering data downloads build users waging history profiles, enabling registered users to receive potentially greater promotional value from participating casinos when requesting air/room travel reservations or promotion offers through the system. Using the waging profile database the system provides individual tailored promotional comp offers to registered users requesting casino destination air/room travel reservation options or promotional offers for walk in casino visits at the system website or at system authorized kiosks.

The invention has been described in terms of several embodiments. It is not intended that the invention be limited in scope to the specific embodiments shown and described. It will be appreciated by those skilled in the art that various changes and modifications may be made without departing from the spirit of the invention.

1. A method of providing wagering profile based offers to potential customers, comprising:
receiving an electronic request from said potential customer for a casino destination reservation;
receiving wagering profile data estimates directly from said potential customer;
attaching potential customer provided wagering profile data to the electronic request;
sending the electronic request, with attached potential customer provided wagering profile data, to one of more casino properties to generate one or more promotional incentive offers corresponding with the request; and
responding to request with at least one reservation and promotional incentive offer.

2. A method in accordance with claim 1, comprising:
registering one or more casino properties for receiving said request.

3. A method in accordance with claim 2, comprising:
providing a customer database of registered customer non-wagering information; and
registering said potential customer prior to receiving said request.

4. A method in accordance with claim 3, comprising:
associating a unique account identifier and a customer database record in said customer database for each registered said potential customer.

5. A method in accordance with claim 4, wherein:
said customer registering step comprises said registered user providing personal identification and contact information and creating a user name and password; and
said method further comprises storing said personal identification and contact information, user name and password in said customer database record.

6. A method in accordance with claim 5, wherein:
said customer registering step comprises said registered user providing at least one of personal gaming preference and wagering profile information; and
said method further comprises storing said at least one of personal gaming preference and wagering profile information provided in said customer database record.

7. A method in accordance with claim 6, wherein:
said customer registering step comprises said registered user providing account numbers for active player card accounts; and
said method further comprises storing said account numbers in said customer database record.

8. A method in accordance with claim 4, wherein:
said customer registering step comprises said registered user providing account numbers for active player card accounts; and
said method further comprises storing said account numbers in said customer database record.

9. A method in accordance with claim 1, wherein:
said first database is associated with a casino management information system for one or more casino properties; and
said casino management information system monitors and tracks waging history data of casino customers.

10. A method in accordance with claim 9, comprising:
storing casino customer wagering history data in said first database.

11. A method in accordance with claim 10, wherein:
updating said first database with wagering profile information collected during each time period that a customer is a registered as being at said one or more casino properties.

12. A method in accordance with claim 11, comprising:
registering a customer at one of said casino properties for purposes of determining said each time period.

13. A method in accordance with claim 12, comprising:
providing a registration kiosk or other terminal located in or proximate each of said casino properties.

14. A method in accordance with claim 13, comprising:
providing to a casino property corresponding to a registration kiosk or other terminal, user identification information for each new user registering at said casino property; and
said casino providing a player account and card for each said new registered user.

15. A method in accordance with claim 11, comprising:
providing said casino customer wagering data collected to said casino property.

16. A method in accordance with claim 1, wherein:
each said request includes travel plans of said potential customer, said plans including one or more dates of departure and dates of return and trip destination location.

17. A method in accordance with claim 16, comprising:
responding to said request with reservation options for air transportation.

18. A method in accordance with claim 16, comprising:
responding to said request with airline reservation options prepared and provided directly by airline operators.

19. A method in accordance with claim 16, comprising:
responding to said request with hotel reservation options prepared and provided directly by participating casino-hotel properties.

20. A method in accordance with claim 1, comprising:
registering said potential customer prior to receiving said request;
said customer registering step comprises said registered user providing at least one of personal gaming preference and wagering profile information; and
storing said at least one of personal gaming preference;
storing said wagering profile information in said first database record; and
preparing said incentive promotional offers on the basis of stored gaming preference and stored wagering profile data collected in said registering step.

21. A method in accordance with claim 20, comprising:
updating said wagering profile data with wagering profile information collected during each time period that a customer is a registered as being at said one or more casino properties.

22. A method in accordance with claim 1, comprising:
providing each of said incentive promotional offers on a “play to qualify” basis.

23. A method in accordance with claim 22, comprising:
determining said promotional incentives a casino property at the end of the time period that a customer is registered at being at said casino property.

24. A method in accordance with claim 23, comprising:
determining an amount or level of promotional incentive offered to a customer based on the amounts wagered by said customer during a stay at a casino property.

25. A method in accordance with claim 1, comprising:
receiving an acceptance by said potential customer of said at least one of said potential incentive offers;
determining whether said potential customer is a new customer to the casino property corresponding to said acceptance; and
said casino property preparing a player card account for said potential customer.

26. A method in accordance with claim 25, wherein:
making said player card available to said customer for pick-up upon arrival at said casino property.

27. A method in accordance with claim 1, comprising:
responding to an acceptance of one of said incentive offers by a customer by determining if said customer is an existing customer of the casino property corresponding to an accepted one of said incentive offers; and
booking said accepted one offer as a casino reservation.

28. A method in accordance with claim 1, comprising:
responding to an acceptance of one of said incentive offers by a customer by providing said potential customer an option to make reservations and/or purchase tickets to entertainment related events and/or shows.

29. A method in accordance with claim 28, comprising:
storing entertainment purchase information relative to said reservations and ticket purchases made by said potential customer; and
providing said entertainment information for said customer to said corresponding casino property.

30. A method in accordance with claim 29, comprising:
said corresponding casino property reimbursing said customer for entertainment purchases at the conclusion of a casino reservation as part of the accepted one of said incentive offers.

31. A method in accordance with claim 1, comprising:
providing a database for storing and aggregating entertainment behavior profiles for said potential customers.

32. A method in accordance with claim 1, comprising:
receiving grading information for a casino property from said prospective customer during or after stay at said casino property by said prospective customer; and
storing said grading information in a database.

33. A method in accordance with claim 1, comprising:
receiving customer provided information relative to promotional incentive offers accepted by said potential customer after utilizing said incentive offer.

34. A method in accordance with claim 1, comprising:
generating comparative grading information for said promotional incentive offers.

35. A method in accordance with claim 3, comprising:
requiring each participating casino to agrees to distribute system promotional material with unique sponsor codes thereon to guests.

36. A method in accordance with claim 35, comprising:
providing instructions in said promotional material for said guests to become registered users;
associating a corresponding unique sponsor code with each said participating casino; and
including in said instructions said corresponding unique sponsor code for use in becoming a registered user.

37. A method in accordance with claim 36, comprising:
associating a registered user account number with the sponsoring casino corresponding to said unique sponsor code for the life of said registered user account.

38. A method in accordance with claim 37, wherein:
said sponsoring casino realizes preferential promotional benefit each time a customer associated with said sponsoring casino enters a request.

39. A method in accordance with claim 38, comprising:
providing said preferential promotional benefit by listing promotional incentive offers from said sponsoring casino in preferential position for viewing by said associated customer.

40. A method in accordance with claim 38, comprising:
providing said preferential promotional benefit via banner ads.

41. A marketing system and method for customer specific promotions, comprising:
receiving an electronic request for a promotional offer from a potential casino customer in a specific casino from a terminal in the casino that accesses a website connected to a global computer network or via a device located in the casino that is connected to a communications network;
receiving wagering profile data estimates directly from said potential customer;
attaching wagering profile data from the requesting customer to the electronic request;
sending the electronic request, with attached potential customer provided wagering profile data, to one or more casino properties to generate one or more promotional incentive offers corresponding with the request;
responding to request with one or more promotional offers.

42. A method in accordance with claim 41, comprising:
providing said enhanced requests to casino properties registered as system participating casino properties.

43. A method in accordance with claim 42, comprising:
registering members of the general public seeking to use the system via a new user registration process to become new registered system users.

44. A method in accordance with claim 43, comprising:
creating a unique system generated account number and customer data file for each said new registered system user.

45. A method in accordance with claim 44, wherein:
said registration process comprises requiring each said new registered system user to provide personal identification and contact information and create a user name and password.

46. A method in accordance with claim 45, comprising:
said registration process comprises requiring each said new registered system user providing personal gaming preference and/or player wagering profile information.

47. A method in accordance with claim 45, comprising:
said registration process comprises requiring each said new registered user to provide account numbers for player card accounts.

48. A method in accordance with claim 44, comprising:
forming said customer data file with at least one of personal, player profile or player card account information for a registered user.

49. A method in accordance with claim 42, comprising:
monitoring and tracking waging history data for casino customers by participating casinos via casino installed management information systems.

50. A method in accordance with claim 49, comprising:
each said participating casino agreeing to provide rights to access and use said casino customer wagering history data.

51. A method in accordance with claim 50, comprising:
each said participating casino providing registered user wagering profile information collected while said registered user is in said participating casino.

52. A method in accordance with claim 51, comprising:
establishing the duration of a registered user's visit to a participating casino by said registered user logging in to and out of said participating casino via a kiosk or other input terminal physically located in said participating casino.

53. A method in accordance with claim 41, comprising:
identifying said customer as a casino property walk-in customer;
determining if said customer is a new customer to a casino property;
said casino property preparing a player account and card for said customer.

54. A method in accordance with claim 53, comprising:
collecting casino customer wagering data and adding said data to said corresponding registered user's customer data file.

55. A method in accordance with claim 41, comprising:
providing as part of each said request intended date and time of arrival and departure and geographical location preference.

56. A method in accordance with claim 46, comprising:
preparing said promotional offers on the basis of said gaming preference and wagering profile data.

57. A method in accordance with claim 41, comprising:
providing said promotional offers on a “play to qualify” basis.

58. A method in accordance with claim 57, comprising:
determining said promotional incentive provided or paid by a casino at the conclusion of a stay at said one or more casino properties.

59. A method in accordance with claim 58, comprising:
determining the amount or level of said promotional incentive provided to said requesting customer based on the amounts wagered by said requesting customer during said stay.

60. A method in accordance with claim 54, comprising:
preparing said promotional offers on the basis of said gaming preference and said added data.

61. A method in accordance with claim 41, comprising:
determining if said requesting customer is a new customer to a casino property corresponding with a promotion option accepted by a requesting customer;
said casino property preparing a player card account for said requesting customer if said requesting customer is a new customer.

62. A method in accordance with claim 61, comprising:
making said player card is available for pick up upon arrival at a casino specified location.

63. A method in accordance with claim 41, comprising:
providing said requesting customer with an option to make reservations and/or purchase tickets to entertainment related events and/or shows.

64. A method in accordance with claim 63, comprising:
said requesting customer accepting one of said one or more promotional offers; selecting said entertainment related events and/or shows from those that are scheduled to occur during the time period of said accepted offer.

65. A method in accordance with claim 64, comprising:
providing to said casino property that provided said accepted one promotional offer, information relative to said entertainment related events and/or shows purchased by said requesting customer.

66. A method in accordance with claim 63, comprising:
automatically storing entertainment behavior profiles in a customer data base for each said requesting customer.

67. The system set forth in claim 44 where upon conclusion of a gaming session corresponding with a system generated promotional offer, said registered user grades the performance of the customer service provided at the corresponding casino and enters such grading data into the system;

68. The system set forth in claim 44 where upon conclusion of a gaming session corresponding with a system generated promotional offer, said registered user provides system with description of the actual promotional incentives received by registered user corresponding with said gaming session;

69. The system set forth in claim 69 where upon receipt of actual promotional incentives received by registered user, the system compares this data with the corresponding wagering profile data received from casino as defined in claim 51 to grade the relative level of promotional incentive provide by said casino;

70. The system set forth in claim 44 where to qualify as a participating casino, said casino agrees to distribute system promotional material, with unique sponsor codes thereon, to their hotel guests;

71. The system set forth in claim 71 where casino distributed promotional material includes instruction for such guests to become registered users, including entering the unique sponsor code during the registration process;
